(19) United States
(12) Patent Application Publication
(10) Pub. No.: US 2013/0333989 A1
(43) Pub. Date: Dec. 19, 2013

(54) BRAKE DISC AND PRODUCTION METHOD THEREOF

(71) Applicant: Ihsan Oezer, Sindelfingen (DE)

(72) Inventor: Ihsan Oezer, Sindelfingen (DE)

(73) Assignee: Daimler AG, Stuttgart (DE)

(21) Appl. No.: 13/981,649

(22) PCT Filed: Dec. 15, 2011
(86) PCT No.: PCT/EP11/06336

§ 371 Date: Jul. 25, 2013

(30) Foreign Application Priority Data
Feb. 25, 2011 (DE) 10 2011 012 320.2

(51) Int. Cl. F16D 65/12

(52) U.S. Cl. CPC F16D 65/127
USPC 188/218 XL; 427/551; 427/446; 427/540

(57) ABSTRACT

A method for the production of a brake disc from a basic body (1), which has a friction ring surface (2). The method includes the steps of the provision of the basic body (1) and the roughening of the friction ring surface (2) by directing an electron beam (5) at the friction ring surface (2). A defined quantity of recesses (3) per mm2 of the friction ring surface (2) is created in the friction ring surface (2). The arrangement of the recesses (3) with respect to one another is predetermined and each recess (3) has a predetermined depth and shape. Then a coating (4) is applied to the friction ring surface without the implementation of an chemical etching step. Furthermore, the invention discloses a corresponding brake disc.

The invention relates to a brake disc for a vehicle and a production method, which comprises in particular a roughening of the friction ring surface of the brake disc.

Vehicle brake discs, which have a coating to reduce the wearing of the friction ring surface are known from the prior art.

In this way, DE 10 342 743 A1 describes a production method of a brake disc for a vehicle as well as the brake disc itself, which comprises a basic body, which has a wear-resistant layer at least in the region of the outer surface, which serves as a friction coating. Furthermore there is a region made from a material which provides adhesion between the basic body and the wear-resistant outer layer, wherein the region made from the material which provides adhesion and the wear-resistant outer layer is formed as a gradual layer, whose composition changes in thickness.

Furthermore, a brake disc is known from DE 10 2004 016 098 A1, which also contains a basic body, which has a wear-resistant layer at least partially in the region of its outer surface, which serves as a friction coating. An intermediate layer is provided as an adhesive layer and/or as an anti-corrosive layer between the basic body and the outer wear-resistant layer, which is applied by electroplating.

The application of the adhesive layer is linked to additional steps in the process and material expenditure, wherein the problem of adhesion of the coated brake discs is at this point mostly not satisfactorily resolved. There is the danger that the coating, in some cases including intermediate layers, could dissolve or flake off, as the mainly firm connection between the layers themselves and between the layers and the surface of the friction surface does not form a sufficiently resistant bond if the brake disc is overloaded during use.

In order to improve the contact surface between the friction ring surface and a protective coating, efforts have already been made to treat the friction ring surface mechanically or through laser structuring in such a way that the contact surface is enlarged.

The mechanical treatment is taken up in EP 1336054 B1, which recommends rotating a brake disc blank by the exact amount that is to be taken up by a coating thickness, followed by the cleaning of the brake disc of process residues, perhaps mechanically, and finally roughening through irradiation with fine corundum or a blasting material with similar properties.

Laser structuring of the surface of a friction ring is a process, which is truly time-consuming, creates a high heat-affected zone and favours cratering at the edges of the component part, so that no satisfactory structuring of the friction ring surface is created hereby.

Fundamentally, the treatment of surfaces of metal work pieces, which are to be coated with layers made of metal, plastic or rubber, are already addressed in the patent application DE 2 318 098: There it states that these work pieces must be roughened or chemically prepared, for example by chemical etching, many times before the application of the coating, wherein a surface forms, which is disadvantageously not uniform. This disadvantage is overcome through the use of electron beams, as a roughening or even melting of certain thickness ranges and zones of the surface can be achieved though more or less high energy supply and focusing of the electron beam, wherein oxides and slags arise through treatment in an atmosphere containing oxygen, which again damage the adhesive properties of the enlarged surface and thus must be cleaned after the electron beam treatment with selected chemicals, in particular by chemical etching.

Based on this prior art, the object of creating an improved method for the treatment of a friction ring surface arises, in order to make this more readily and durably connectible with a protective coating.

This object is solved by a method having the features of claim 1.

Furthermore, the object arises of creating a brake disc, which has an improved connection between a friction ring surface of the basic body and a protective coating.

This object is solved by the brake disc having the features of claim 4.

Developments of the method and the device are embodied in the respective sub-claims.

The method according to the invention for the production of a brake disc from a basic body, which has a friction ring surface, which is to be provided with a coating, provides, in a first embodiment, the steps firstly to provide the basic body and then to roughen the friction ring surface by directing an electron beam at the friction ring surface, thus creating a defined quantity of recesses per square millimetre of friction ring surface. Regarding its energy, direction and distance from the surface to be processed the electron beam is adjusted in such a way that the arrangement of the recesses with respect to one another is carried out in a predetermined way and each recess has a predetermined depth and shape.

As a chemical etching step or another such cleaning or intermediate step does not have to be carried out, the application of a coating for the friction ring surface can now be carried out. In this way, chemical etching for the elimination of slag residues on the roughened surface can be dispensed with, if the electron beam process is carried out in an oxygen-free atmosphere or in a vacuum, for example. But even when this is not the case, and slags, etc. form on the friction ring surface because of the presence of oxygen during the irradiation with oxygen, a chemical etching step is not necessary, as the application of the coating which is subsequently carried out is such that potentially existing slag residues are hereby either eliminated or incorporated into the structure.

In this way a reliable and reproducible method to optimise the friction ring surface is advantageously created, which enables better connection, by mechanical clamping, with the material which forms the coating, due to the surface of the friction ring being enlarged by two to six times. The structuring process carried out with the electron beam thus advantageously requires only short cycle times and allows a subsequent optimised gradual construction of coating.

To that end, the electron beam is a sharply focused and highly accelerated electron beam, which allows the recesses on the friction ring surface to be realised with the desired quantity and shape. To avoid the formation of slag on the friction ring surface, the irradiation of the friction ring surface can be carried out in an atmosphere with low oxygen levels, in particular in an atmosphere of inert gas, as is mentioned above.

The subsequent application of the coating of the friction ring surface, which has resistant materials in the form of carbides or oxide ceramics, onto the basic body of the brake disc, which consists of a metallic material such as, in particular, grey cast iron, steel or aluminium alloy, is carried out by means of a high-speed flame spraying, plasma spraying, cold gas spraying or arc wire spraying. This application method enables a coating directly after the roughening, as the potentially existing slag residues are either eliminated or incorporated into the resulting structure.

The carbides or the oxide ceramic of the coating are available to be connected through a connection phase or a matrix, which are formed by alloys based on chromium, nickel and/or iron. Added to this list are also chromium or chromium nickel steels.

The brake disc created using the method according to the invention, made from a basic body with a friction ring surface, which is provided with a coating, thus has a predetermined quantity per square millimetre of recesses on the friction ring surface of the basic body, which are created by an electron beam, and are introduced into the friction ring surface according to a predetermined arrangement with respect to one another or even as a pattern. Each recess has a predetermined depth and shape. Advantageously, the coating then forms a combined firm and positive connection with the recesses of the friction ring surface without an intermediate layer.

Through the recesses and as a function of their quantity, shape and size, a friction ring surface between two and six times larger is produced, compared to a friction ring surface without recesses.

The basic body of the brake disc consists of a metallic material, wherein a grey cast iron is preferred, which can be, processed with particular suitability for the measures according to the invention.

The coating of the friction ring surface has, with respect to the total weight of the coating,

70-85% b.w. WC, 7-12% b.w. Co, 3-5% b.w. Cr, 0.5-2% b.w. Ni, or
75-85% b.w. WC, 7-12% b.w. Co, 3-5% b.w. Cr, 0.001-1% b.w. Ni, or
65-85% b.w. WC, 15-30% b.w. Cr₃C₂, 5-12% b.w. Ni, or
70-75% b.w. WC, 18-22% b.w., 5-8% b.w. Ni, as well as impurities.

Oxide ceramics, for example, are chosen for the ceramics in the coating of the friction ring surface mentioned above, in particular coatings containing magnesium oxide, zirconium dioxide, titanium dioxide and/or aluminium oxide.

The coating of the friction ring surface can also have an oxide ceramic and a metal matrix as connection material, wherein the oxide ceramic and the metal matrix are produced in a ratio from 50-80% to 20-50%. The metal matrix is, for example, formed of Cr/Ni steel.

These and other advantages are demonstrated by the description below with reference to the accompanying figures. The reference to the figures in the description serves to support the description and to facilitate understanding of the subject matter.

Here are shown:

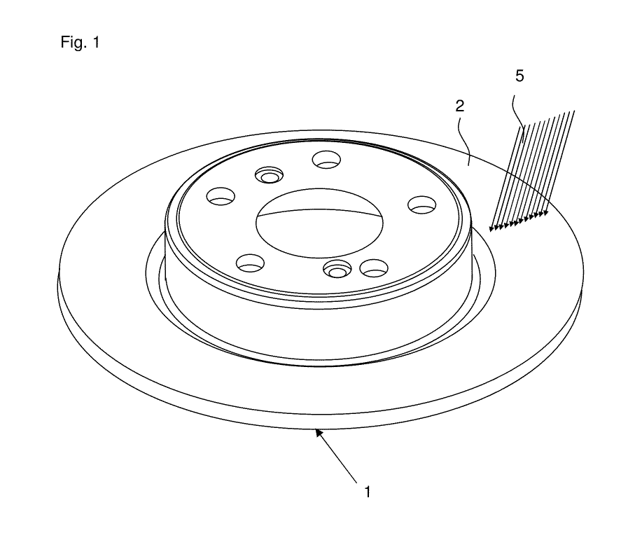

FIG. 1 a perspective view of a brake disc during use of the electron beam,

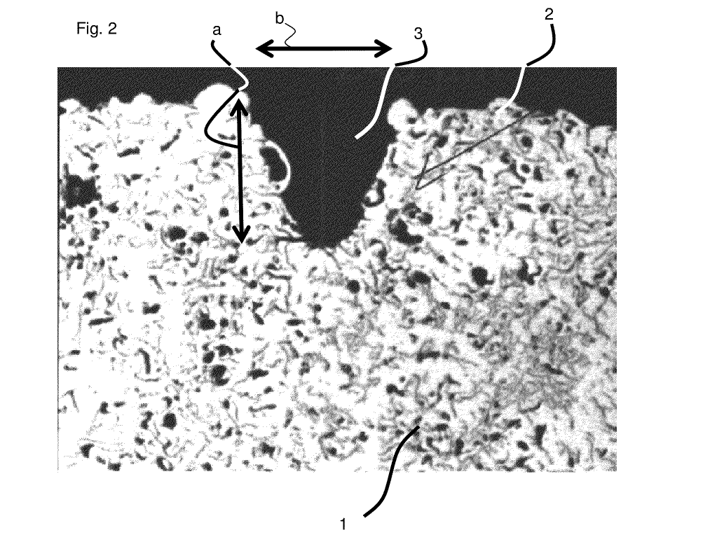

FIG. 2 an electron-microscopical cross-sectional view of a recess,

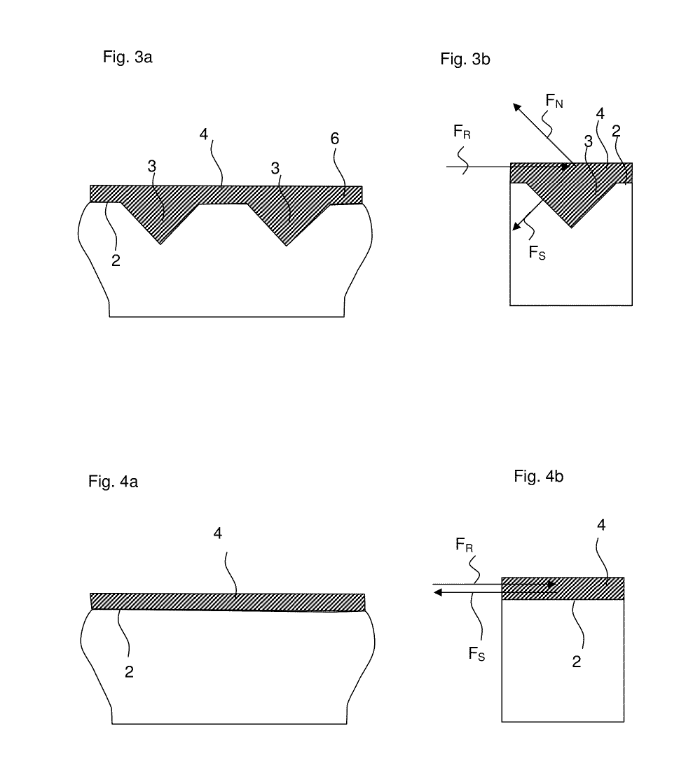

FIG. 3a a schematic side sectional view through two recesses in the friction ring surface, which is provided with a coating, according to one embodiment of the invention,

FIG. 3b a schematic side sectional view through a recess in the friction ring surface, which is provided with a coating, with force vectors, according one embodiment of the invention,

FIG. 4a a schematic side sectional view of a friction ring surface, which is provided with a coating, according to prior art,

FIG. 4b a schematic side sectional view of the friction ring surface, which is provided with a coating, according to prior art, with force vectors,

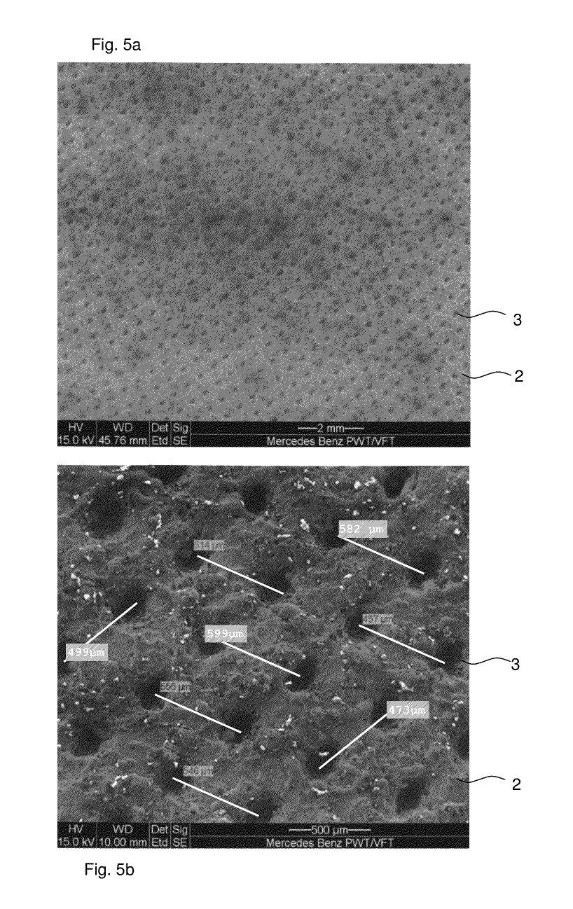

FIG. 5a an electron-microscopical scan of the friction ring surface with the recesses according to one embodiment of the invention,

FIG. 5b an enlarged electron-microscopical scan of the friction ring surface with the recesses according to one embodiment of the invention,

The invention relates to a method for the production of a brake disc made from a basic body 1, which has a friction ring surface 2, as can been seen in FIG. 1. A wear-resistant layer is to be applied to the friction ring surface 2. In order that this adheres better, the friction ring surface 2 is roughened before being coated, through the use of electron beams 5 being directed at the friction ring surface 2, by means of which a defined quantity of recesses 3 (which can been seen in the electron-microscopical scans in FIG. 2 and FIG. 5a, b) per square millimetre of the friction ring surface 2 are introduced, wherein the arrangement of the recesses 3 with respect to one another is predetermined and, wherein each recess 3 has a predetermined depth and shape.

Then the coating to protect against wear 4 is applied without subjecting the roughened friction ring surface to a chemical etching step, which can be seen in FIGS. 3a and 3b. The surface quality of the friction ring can thus be influenced through the specifically created surface contours, the defined quantity thereof and the precisely defined geometries thereof, so that a desired surface geometry can be produced specifically for the friction ring to be coated.

The roughening of the friction ring surface 2 is carried out through the directed electron beams 5 in the form of individual radiated electrons. The electron beam processing is based on the energy conversion on the impact of the sharply focused and highly accelerated electron beam 5 onto the surface 2 to be structured. The electrons are decelerated on impact with the boundary layer of the surface 2, wherein their kinetic energy is converted into heat energy in a focal spot. The entry depth of the electrons into the boundary layer is a function of their speed and thus of the acceleration voltage, as well as the thickness of the charged material. Due to the high power density in the focal spot, the material in this area is melted and partially evaporated within a few microseconds. Due to the resulting vapour pressure, melt droplets are forced outwards from the point of impact of the beam. If the electron beam is turned off immediately after permeation of the work piece, then a capillary will still exist.

To avoid oxide and slag formation in the region around the focal spot, the irradiation of the friction ring surface 2 can be carried out in an atmosphere with low oxygen levels, in particular in an atmosphere of inert gas.

The coating 4 which is applied to the friction ring surface 2 of the basic body 1 by means of high-speed flame spraying, plasma spraying, cold gas spraying or arc wire spraying, then forms a combined firm and positive connection without an intermediate layer with the friction ring surface 4, which has been roughened by the recesses 3.

Thus, and due to the fact that the relatively small contact area between the coating 4 and the friction ring surface 2 is increased, the danger of the coating 4 failing to adhere or flaking off is decreased. The mechanical connection between a coating and a friction ring surface, which has until now been undefined, could thus be improved and optimised. The method according to the invention provides a reliable and reproducible surface optimisation, wherein through a surface, which is enlarged by two to six times depending on the construction of the surface structure, a better adhesion and mechanical connection between the basic body of the brake disc 1 and the respective coating is achieved. Additionally, the very fast structuring process enables short cycle times as well as an optimised coating construction, such as for example a gradual construction of the coating.

A brake disc according to the invention is formed from the basic body 1 and a coating 4 which is applied to the friction ring surface 2. The basic body 1 is made from a metallic material, for example from grey cast iron. Further possible materials for the basic body include steel or a light metal alloy, for example with a foundation of aluminium. The coating 4 on the friction ring surface 2 consists of a hard material, which acts a wear-resistant material. Suitable materials for this are resistant materials, carbides and/or oxide ceramic. In this way suitable materials for a coating to protect against the wear of a friction ring surface are also cermets (ceramic metal composites), CMCs (ceramic fibre composites) and MMCs (metal matrix composites with embedded particles of resistant materials), which have excellent tribological properties as well as protection against wear.

An exemplary coating 4 deals with carbides made from tungsten and/or from chromium, which are embedded in a metallic matrix made of nickel, cobalt and/or chromium.

The WC proportion is here in the region of 60-85%. (Unless otherwise stated, the information in % is always understood to be percentage by weight).

The proportion of metallic matrix, which fundamentally serves to connect the embedded carbides, is in the region of 10-50%, preferably in the region of 15-25%.

In this case, in particular alloy compositions with a high proportion of Co are preferred for the metallic matrix, wherein the coating has in particular proportions of 6-15% Co, 2-6% Cr and 0.001-3% Ni, as well as traces of other metals if necessary.

A typical preferred composition for a coating comprises 70-85% WC, 7-12% Co, 3-5% Cr and 0.5-2% Ni as well as impurities. Another typical preferred composition for a coating comprises 75-85% WC, 7-12% Co, 3-5% Cr and 0.001 to 1 Ni, as well as impurities.

A further embodiment of the coating 4 deals with a metal-bonded carbide WC—Co—Cr—Ni, which has a composition of preferably approximately 10% b.w. Co, 4% b.w. Cr and preferably approximately 1% b.w. Ni and the rest WC.

In this case, in these coating compositions, Cr can also be at least partially joined as a carbide.

A further metallic matrix which is well suited to the creation of the coating to protect against wear is characterized by a high Ni content. WC and Cr₃C₂ as resistant materials arise as substantial components of this coating, which together make up a proportion of 70-90% of the coating.

For this type of coating to protect against wear, typical preferred compositions for a coating comprise 65-85% WC, 15-30% Cr3C2 and 5-12% Ni as well as impurities or 70-75% WC, 18-22% Cr₃C₂ and 5-8% Ni, as well as impurities.

A preferred composition of this type of WC—Cr₃C₂—Ni coating has a proportion of approximately 73% b.w. WC, a proportion of approximately 20% b.w. chromium carbide and a proportion of approximately 7% b.w. Nickel.

Further suitable carbide coatings can also be created from a chromium steel. In this case the resistant materials substantially consist of Cr-carbides. The preferred steels have a proportion of chromium of 12-22% b.w. A proportion of 15-20% Cr is, however, preferred.

In a further preferred embodiment, the basic body (1) consists of a metallic material, in particular of a grey cast iron, and the coating (4) of the friction ring surface (2) consists of oxide ceramic, in particular selected from the group Al₂O₃, ZrO₂, MgO and/or TiO₂, and metal, in particular Cr/Ni steel.

These coatings are preferably applied to the friction ring surface by means of high-speed flame spraying, plasma spraying, cold gas spraying or arc wire spraying. The high-speed flame spraying is particularly suited to the creation of a carbide coating. The plasma spraying is suited to the creation of a coating made from ceramic, cermet or metal. It is also possible to use the cold gas spraying and the arc wire spraying in the creation of a coating made from metal.

When using the high-speed flame spraying, spray particles of the coating material are applied at a very high speed to the friction ring surface 2 to be coated. When using the plasma spraying, the coating material is introduced into a plasma gas stream in powder form, which is melted by the plasma and, through the plasma gas stream, sprayed onto the friction ring surface 2 to be coated.

When using the cold gas spraying, the coating material is sprayed onto the friction ring surface 2 to be coated in powder form at a very high speed. In this case, the coating material, which is in powder form, is accelerated to such a high speed that, in contrast to other thermal spray processes, it also forms a thick and firmly adhering layer on the friction ring surface 2 to be coated, without melting or fusing on impact.

When using arc wire spraying, spray particles, melted by means of an arc wire, are sprayed onto the friction ring surface 2 to be coated by means of an atomising gas.

The spray particles respectively have a high energy content, as a result of which the firm connection with the friction ring surface occurs, whilst slags or oxides, which potentially exist on the friction ring surface, are eliminated or integrated into the resulting structure and thus the adhesion of the coating to the friction ring surface is not compromised or only compromised to a small degree.

In FIG. 2, there can be seen the outline, generated after the electron irradiation, of a recess 3 in the surface 2 of a brake disc basic body 1 made from a grey cast iron GG-20. Here the recess 3 has a diameter b of approximately 250 μm on the surface 2. The depth of the recess 3 also has a depth of approximately 250 μm. The surface at this location was approximately double due to the dimensions of the recess. Instead of the circular area with the diameter b, the lateral surface and the base surface of the recess 3 are the surfaces in question. Due to a plurality of such recesses 3, a mechanical clamping between the friction ring surface 2 and the coating, 4 and thus a clearly firmer connection, can additionally be achieved outside of the adhesive bond through the application method, whereby the adhesive strength of the coating 4 on the friction ring surface 2 is also clearly increased. This is clarified in FIGS. 3a to 4b.

Whilst in FIGS. 3a and 3b the stress of the coating 4, which, due to the connection embodied according to the invention between the coating 4 and the friction ring surface 2, is optimised by the recesses 3, is depicted, in FIGS. 4a and 4b the original stress direction of a coating 4 according to the prior art is outlined, which was determined during the braking by shearing forces F_{S} due to the occurring frictional forces F_{R}, which is substantially radial or parallel to the friction ring surface in the peripheral direction. The coating 4, which is applied to the planar friction ring surface 2 of the brake disc without surface structuring according to prior art, is thus applied by reinforced shear stress, which can promote a flaking of the coating 4.

FIG. 3a shows a section of a brake disc with recesses 3 of predetermined depth introduced into the friction ring surface 2, which are produced by means of electron beams. The coating 4 which is applied thereafter engages with the recesses 3 and is thus firmly and positively connected to the friction ring surface. FIG. 3b shows the breakdown of force of the friction force F_{R}, which acts on the coating 4 during the braking process, into a force vector F_{S} and F_{N} which runs perpendicular and parallel to a wall of the recess 3. According to the created outline geometry of the recess 3, the stress direction now runs partially in a perpendicular direction, which decreases the shear stress and overall clearly increases the durability of the coating 4.

FIG. 5a shows an overview scan of a friction ring surface 2, produced according to the invention, having a plurality of recesses 3. With the given measurement of 2 mm, a concentration of recesses of approximately 4 recesses per mm², which are arranged here in a lozenge-forming pattern, is to be gleaned. The arrangement of the produced recesses can be selected and designed in any way due to the high level of accuracy of the electron beam method.

In FIG. 5b, there can be seen an enlarged view of the friction ring surface 2 from FIG. 5a, produced according to the invention, which clarifies the arrangement of the recesses 3. The pattern of the recesses 3 can be considered as points created in parallel lines, wherein the points are arranged on a line with a determined distance between one another, and wherein the points of neighbouring lines are arranged with displacement to one another respectively at half the determined distance. The distance of the lines from one another is chosen so that one point on one line is also in turn arranged at a predetermined distance away from one point on the other line. Here, the predetermined distance has an average length of approximately 500 μm. Here, this is an arrangement of the recesses 3, which is optimised with respect to an optimal connection between the coating 4 and the friction ring surface 2.

In summary, the roughening according to the invention by means of electron beams produces a highest process speed, whilst the electron beams enable a highest flexibility during the arrangement of the roughened surface contours. The boundary layer is clearly increased, wherein a clearly higher adhesion between the coating and the friction ring surface is achieved.

Due to the increased layer thicknesses produced in the regions of the recesses, the heat conduction of the friction surface in the brake disc basic body, which is formed by the layer of protection against wear, is reduced and thus the general thermal resistance of the connection system is increased. Thus neither an adhesive layer nor a heat insulating layer is necessary between the layer to protect against wear and the basic body.

Through the chosen geometry of the recesses, the original stress direction (shear stress) in the coating can be converted into a normal force and shear stress.

Furthermore, a gradual construction of the coating to be sharpened is guaranteed by the outline of the recesses after the electron beams. Thus the danger of cracking for the relatively thick thermal coatings is more or less eliminated. The setting, which occurs immediately after the thermal spraying of the coating, causes very high residual stresses in cases of larger layer thicknesses, which as a consequence can cause cracking. The gradual construction of the layer in the outline avoids this.

In this way, through the configured arrangement of the recesses and the balancing of the stress peaks in the coating, the possible formation of cracks in the case of higher brake stresses is also reduced.

Finally, the brake disc according to the invention can be manufactured at low cost, as more cost-effective grey cast iron can be used as the material for the basic body of the brake disc. The coating provides the brake disc with a higher resistance to wear. Additionally, a weight reduction and a reduction of corrosion in the brake disc can thus be achieved. Furthermore, the coating offers a consistent adhesion factor of the brake disc and a reduction of temperature produced when braking, wherein the so called brake fade, meaning a brake failure as a result of overheating can be avoided. Finally, due to a reduction of vibrations and noise, achieved with the coating, an increase in comfort can be achieved.

1. A method for the production of a brake disc from a basic body (1), which has a friction ring surface (2), comprising the steps:
providing the basic body (1) and roughening the friction ring surface (2) by directing an electron beam (5) at the friction ring surface (2), thus producing, in the friction ring surface (2), a defined quantity of recesses (3) per mm² of the friction ring surface (2), wherein the arrangement of the recesses (3) with respect to one another is predetermined and wherein each recess (3) has a predetermined depth and shape, and
applying a coating (4) to the friction ring surface without the implementation of a chemical etching step.

2. The method according to claim 1, wherein the electron beam (5) is a sharply focussed and highly accelerated electron beam (5) and wherein that the irradiation of the friction ring surface (2) is carried out in an atmosphere, which is low in oxygen.

3. The method according to claim 1, wherein the application of the coating (4) of the friction ring surface is carried out by means of high-speed flame spraying, plasma spraying, cold gas spraying or arc wire spraying.

4. A brake disc made from a basic body (1) with a friction ring surface (2), which is provided with a coating (4), wherein the friction ring surface (2) of the basic body (1) has a predetermined quantity of electron-irradiated recesses (3) per mm² which are positioned on the friction ring surface (2) according to a predetermined arrangement with respect to one another and wherein each recess (3) has a predetermined depth and shape, and wherein the coating (4) forms a combined positive and firmly bonded connection with the recesses (3) of the friction ring surface (4) without an intermediate layer.

5. The brake disc according to claim 4, wherein the quantity, shape and depth of the recesses (3) has a friction ring surface (2) that is 2-6 times larger compared to a friction ring surface (2) without recesses.

6. The brake disc according to claim 4, wherein the basic body (1) consists of a metallic material, and the coating (4) of the friction ring surface (2), with respect to the total weight of the coating, has:
70-85% b.w. WC, 7-12% b.w. Co, 3-5% b.w. Cr, 0.5-2% b.w. Ni, or
75-85% b.w. WC, 7-12% b.w. Co, 3-5% b.w. Cr, 0.001-1% b.w. Ni, or
65-85% b.w. WC, 15-30% b.w. chromium carbide, 5-12% b.w. Ni, or
70-75% b.w. WC, 18-22% b.w. chromium carbide, 5-8% b.w. Ni, as well as impurities.

7. The brake disc according to claim 4, wherein the basic body (1) consists of a metallic material, in particular a grey cast iron, and the coating (4) of the friction ring surface (2) consists of oxide ceramic, in particular selected and metal.

8. The method according to claim 2, wherein the irradiation of the friction ring surface (2) is carried out in an atmosphere of inert gas.

9. The brake disc according to claim 6, wherein the basic body (1) consists of a grey cast iron.

10. The brake disc according to claim 6, wherein the friction ring surface (2), with respect to the total weight of the coating, has:
65-85% b.w. WC, 15-30% b.w. Cr₃C₂, 5-12% b.w. Ni, or
70-75% b.w. WC, 18-22% b.w. Cr₃C₂, 5-8% b.w. Ni, as well as impurities.

11. The brake disc according to claim 7, wherein the basic body (1) consists of a grey cast iron.

12. The brake disc according to claim 7, wherein the coating (4) of the friction ring surface (2) consists of and metal.

13. The brake disc according to claim 7, wherein the coating (4) of the friction ring surface (2) consists of ceramic and Cr/Ni steel.
